(19) United States
(12) Patent Application Publication
(10) Pub. No.: US 2018/0087742 A1
(43) Pub. Date: Mar. 29, 2018

(54) QUASI-OMNIDIRECTIONAL QUASI-POINT SOURCE FOR IMAGING OR COLLIMATED OPTICAL SYSTEM AND METHOD OF OPERATION THEREOF

(71) Applicant: Kevin Stone, Farmers Branch, TX (US)

(72) Inventor: Kevin Stone, Farmers Branch, TX (US)

(21) Appl. No.: 15/712,627

(22) Filed: Sep. 22, 2017

Related U.S. Application Data
(60) Provisional application No. 62/398,606, filed on Sep. 23, 2016.

(51) Int. Cl. F21V 7/00; F21K 9/20

(52) U.S. Cl. CPC F21V 7/0058; F21Y 2105/14; F21K 9/20

(57) ABSTRACT

A quasi-point source light emitter includes a polyhedral core having a plurality of flat polygonal faces structurally arranged for a quasi-omnidirectional point source. The quasi-point source light emitter additionally includes planar light emitting devices or arrays thereof located on the plurality of flat polygonal faces and having planar light emitters that are controlled individually or controlled collectively for the quasi-omnidirectional point source. A method of operating a quasi-point source light emitter is also provided.

### CROSS-REFERENCE TO RELATED APPLICATION

This application claims the benefit of U.S. Provisional Application Ser. No. 62/398,606, filed by Kevin Stone on Sep. 23, 2016, entitled “QUASI-OMNIDIRECTIONAL QUASI-POINT SOURCE FOR IMAGING OR COLLIMATED OPTICAL SYSTEM AND METHOD OF OPERATION THEREOF,” commonly assigned with this application and incorporated herein by reference.

### TECHNICAL FIELD

This application is directed, in general, to optical systems, such as imaging or collimated optical systems.

### BACKGROUND

Light-emitting diodes and other planar emitters are light sources that impose certain limitations on conventional optical systems designed for use with omnidirectional point sources such as arc lamps and tungsten filament bulbs.

Specifically, rays from light sources whose output is shaped by reflectors in collimating and imaging optical systems are only shaped where they intersect the reflector itself. Because a reflector requires an aperture from which the shaped beam must escape, rays constituting the cone of light defined by the tangent from the quasi-point source of the emitter to the edge of the reflector at the aperture are not shaped. These rays are effectively “lost” output with respect to the desired collimated or focused beam.

In a true point source, the cone of lost light defined by the tangent represents a fractional percentage of total light output from a theoretical full sphere of light emission. Because there is no such thing as a true point source, there is also a smaller cone of light lost to the obstruction of the point source itself as well as any supporting mechanism, but this is generally inconsequential.

By contrast, a planar emitter radiates light in only an approximately hemispheric pattern. By definition, any cone of light lost to escape of the optical system within the cone defined by the tangent to the reflector edge is approximately twice the relative percentage as that same cone relative to a source emitting in a fully spherical pattern. One may safely surmise that a planar emitter suffers roughly twice the light loss to unshaped rays as does a point source emitter of the same luminous output within a collimating or imaging optical system using a typical reflector, such as a paraboloid or ellipsoid.

Additionally, the ability to focus or collimate a beam in a given optical system is largely determined by a ratio known as etendue, which is defined as the product of the area of the source and the solid angle that the system's entrance pupil subtends as seen from the source. Put simply, the peripheral extent of an emitter with a large surface area dictates a greater angular range of deviation from perfect focus or collimation for a given focal geometry. Reducing the diametric extent of an emitter improves focus and collimation as increasing the diametric extent of the emitter worsens it. A quasi-spheroid, therefore, has reduced etendue relative to a planar surface of the same area, or a greater emitting surface relative to a planar surface of the same diametric extent.

### SUMMARY

One embodiment is a quasi-point source light emitter. The quasi-point source light emitter includes a polyhedral core having a plurality of flat polygonal faces structurally arranged for a quasi-omnidirectional point source. The quasi-point source light emitter additionally includes planar light emitting devices or arrays thereof located on the plurality of flat polygonal faces and having planar light emitters that are controlled individually or controlled collectively for the quasi-omnidirectional point source.

Another embodiment is a method of operating a quasi-point source light emitter. The method of operating a quasi-point source light emitter includes arranging a plurality of flat polygonal faces to form a quasi-omnidirectional point source and energizing planar light emitting devices or arrays thereof on the plurality of flat polygonal faces, wherein planar light emitters are controlled individually or controlled collectively to provide the quasi-omnidirectional point source.

### BRIEF DESCRIPTION

Reference is now made to the following descriptions taken in conjunction with the accompanying drawings, in which:

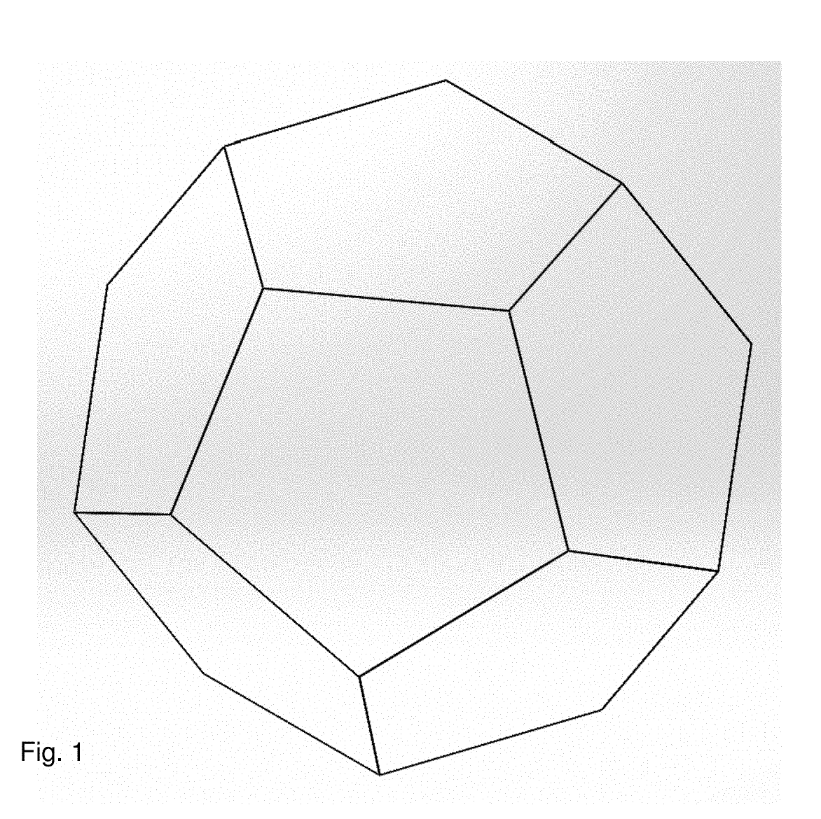

FIG. 1 is an oblique view of one embodiment of a polyhedral core, specifically a dodecahedron, to which individual chips, circuit boards or rigid-flex circuits may be applied;

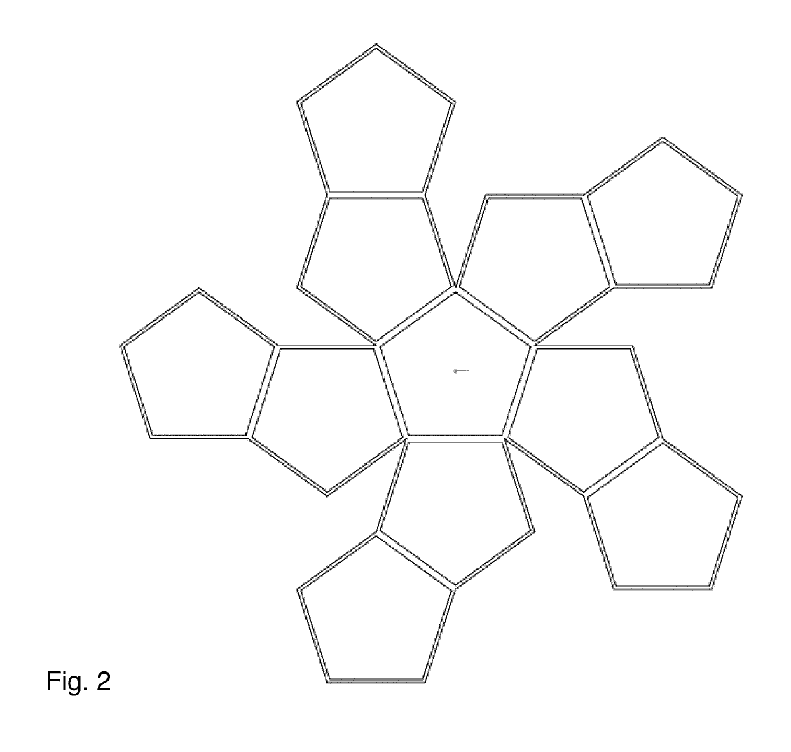

FIG. 2 is an unfolded plan view of an embodiment of a rigid-flex circuit to be applied to the polyhedral core of FIG. 1, leaving one face open for the purpose of heat extraction;

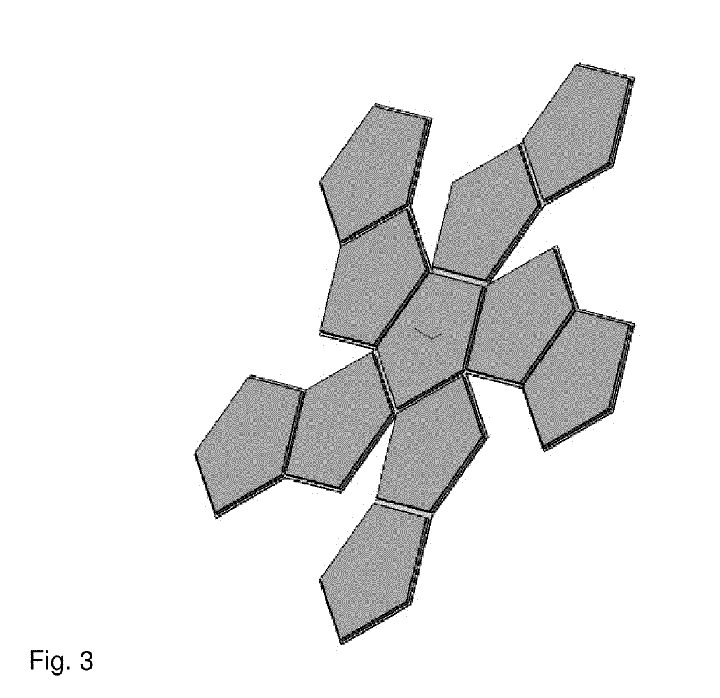

FIG. 3 is an unfolded isometric view of an embodiment of a rigid-flex circuit to be applied to the polyhedral core of FIG. 1, leaving one face open for the purpose of heat extraction;

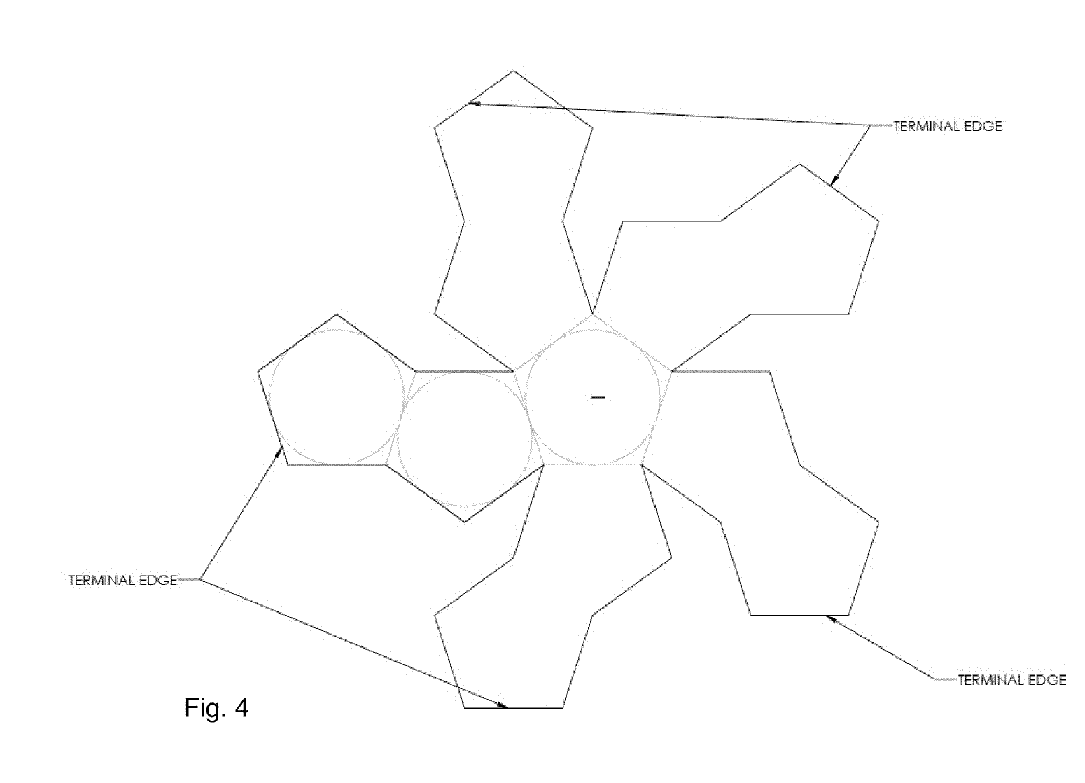

FIG. 4 is an unfolded plan view of an embodiment of a flexible circuit board substrate, such as a nanoceramic composite, configured to be bonded to facets of the polyhedral core of FIG. 1;

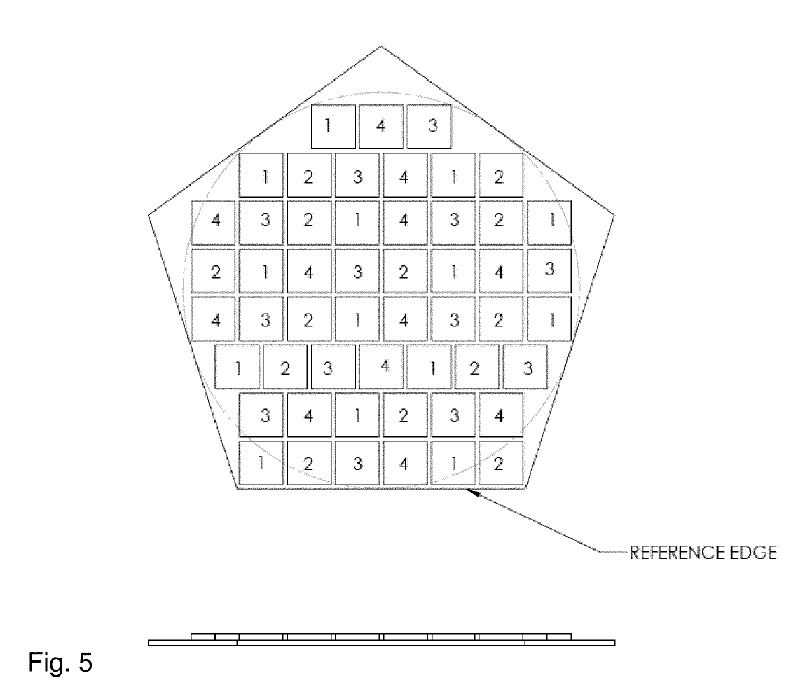

FIG. 5 is a plan view of one embodiment of an LED array in which LED chips are located on a polygonal circuit board reflecting the shape of a facet of the polyhedral core of FIG. 1 and in which numbers 1-4 represent differing color values or color temperature values of LED chips; and

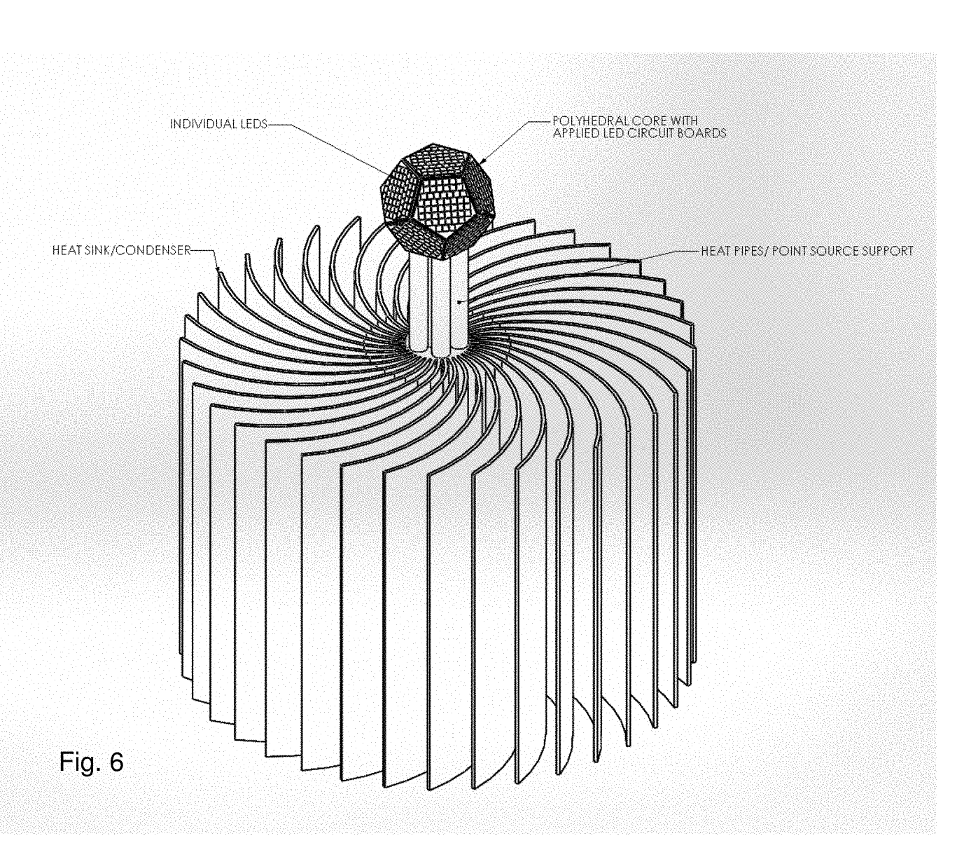

FIG. 6 is an isometric view of one embodiment of a polyhedral core, one embodiment of a thermally conductive or heat pipe support coupled to the polyhedral core and one embodiment of a heat exchanger coupled to the support.

### DETAILED DESCRIPTION

One aspect provides a quasi-point source three-dimensional array of planar emitters located on faces of a polyhedral core, mounted to a support so as to locate the polyhedral core at or near a focal point of an optical system. In various embodiments, the emitters are placed directly on a dielectric core imprinted with circuit traces, applied as discrete circuit boards that are inset into the individual faces of the polyhedral core, or are a flex or hybrid rigid-flex circuit board that is folded and applied to the polyhedral faces. In various embodiments, the emitters are individual diodes, “chip on board” (COB) integrated arrays, or discrete arrays in which chips are mounted in a desired pattern on the circuit board/s that are applied to the faces of the polyhedral core. In various embodiments, the chips are of a uniform value (such as a common color or color temperature) or a pre-determined set of colors or color temperatures, that may or may not be controlled individually as discrete channels for the purpose of varying mixed color or color temperature.

Because the individual planar faces, which represent facets of the polyhedral core, have less surface area than a single planar surface containing the sum of emitters spread across the multiple facets of the polyhedral core, creating a polyhedron with a lesser diametric extent than the described single planar surface, the solid angle subtended by the etendue for the sum of the faces of the polyhedron is substantially reduced relative to the solid angle subtended by the etendue of the single planar surface representing the same number of emitters.

Moreover, rather than using a single large planar face emitting normal to the exit aperture, in which case a maximal portion of the emitted light is lost to the tangent cone, only one small planar face (at maximum) emits normal to the exit aperture, while other faces are substantially rotated toward the beam-shaping optic, thereby losing less of their overall emitted light to the described conic area. Consequently, a much lesser percentage of overall light emission escapes the aperture without being shaped by the optical surface, and indeed the face or faces exhibiting high spill loss may be left unpopulated so as to minimize light lost to spill.

As LEDs continue to replace conventional light sources due to their long service life and relatively power efficient nature, an improved means of efficiently collecting light from them is desired. Because they are planar emitters, this presents a challenging issue.

Introduced herein are various embodiments of a quasi-omnidirectional, quasi-point source having multiple individual, or patterned sets of, planar emitters regularly arrayed on the facets of a polyhedral core with the emitting surfaces facing outward and directed into a reflector or waveguide constituting, along with the emitters, an optical system, typically collimating or imagining, with at least one facet or portion thereof reserved for attachment of a mount used to position the polyhedral core at the focal point of the described optical system.

In one embodiment of the invention, the polyhedral core is a regular polyhedral core formed of identical faces (such as a cube or a dodecahedron). FIGS. 1 through 6 hereof show a dodecahedron. However, those skilled in the pertinent art will readily understand how other polyhedrons may be employed to form a point source falling within the scope of the invention introduced herein.

In another embodiment of the invention, the polyhedral core is an irregular polyhedral core formed of at least two sets of dissimilar faces.

In one embodiment of the invention, the emitters attached to the faces of the polyhedral core are single emitters, such as single LED chips or integrated COB arrays.

In another embodiment of the invention, the emitters attached to the faces of the polyhedral core are multiple sources arrayed in a compact pattern on each facet of the polyhedral core.

In one embodiment of the invention, the emitters are of a uniform value (i.e., color, brightness, color temperature).

In another embodiment of the invention, the emitters are of dissimilar value.

In one embodiment of the invention in which the emitters are of uniform or dissimilar value, the emitters are not individually controllable and emit at a fixed sum value of intensity, color or color temperature.

In another embodiment of the invention in which the emitters are dissimilar, the emitters or sets of emitters are individually dimmable so as to provide variation in intensity, color or color temperature of the array.

In one embodiment of the invention, the polyhedral core is a thermally passive material used solely as a mounting surface.

In another embodiment of the invention, the polyhedral core is a thermally conductive heat sink used to conduct heat away from the emitters.

In one embodiment of the invention, the emitters are directly mounted to the polyhedral core on whose dielectric surface are etched electrically conductive traces constituting the system circuit board.

In another embodiment of the invention, the emitters are mounted to individual circuit boards that are separately mounted to the facets of the polyhedral core and electrically connected into a circuit or set of circuits, attached to the polyhedral facets as by adhesive or other means of bonding.

In yet another embodiment of the invention, the emitters are mounted to a flexible or hybrid rigid-flex circuit board whose design allows it to be “wrapped” to conform to the facets of the polyhedral core, attached to the polyhedral facets as by adhesive or other means of bonding.

In one embodiment of the invention, heat generated by the emitters is passively removed from the system, as by convection.

In another embodiment of the invention, heat generated by the emitters is actively removed from the system by moving air, such as that introduced by a fan.

In yet another embodiment of the invention, heat generated by the emitters is actively removed from the system by a heat exchanger, such as a heat pipe arrangement in which the polyhedral core is used as an evaporator into which are mounted heat pipes whose opposite ends are attached to a heat sink condenser.

In yet another embodiment of the invention, heat generated by the emitters is actively removed from the system by a solid state cooling apparatus, such as a Peltier plate, thermally coupled to the polyhedral core.

In yet another embodiment of the invention, heat generated by the emitters is actively removed from the system by a liquid cooling system in which a fluid medium traverses the polyhedral core inside thermally conductive tubes then flows into a radiator or similar system that extracts heat carried by the liquid from the polyhedral core.

FIG. 1 is an oblique view of one embodiment of a polyhedral core, specifically a dodecahedron, to which individual chips, circuit boards or rigid-flex circuits may be applied. A pentagonal circuit board may be applied to each facet of the polyhedral core. Alternatively, a flex circuit board may be designed to fold over and be bonded to a plurality of, or all of, the facets of the polyhedral core.

FIG. 2 is an unfolded plan view an embodiment of a rigid-flex circuit to be applied to the polyhedral core of FIG. 1, leaving one face open for the purpose of heat extraction;

FIG. 3 is an unfolded isometric view of an embodiment of a rigid-flex circuit to be applied to the polyhedral core of FIG. 1, leaving one face open for the purpose of heat extraction;

FIG. 4 is an unfolded plan view of an embodiment of a flexible circuit board substrate, such as Kapton or a nanoceramic composite, configured to be bonded to facets of the polyhedral core of FIGS. 1-3. FIG. 4 shows one embodiment of terminal edges of the flex circuit. The underlying flexible board drawing shows only the Kapton (or similar) flex material to which LEDs or rigid circuit board would be electrically bonded, with the center polygon (pentagon, in this case) affixing to a “top” (outward facing, relative to the optical system) facet of the polyhedron and the “terminal edges” abutting the edges of the opposite facet into which the support for the point source is inserted.

FIG. 5 is a plan view of one embodiment of an LED array in which LED chips are located on a polygonal circuit board reflecting the shape of a facet of the polyhedral core of FIG. 1 and in which numbers 1-4 represent differing color values or color temperature values of LED chips. In FIG. 5, the emitters are of dissimilar color value and individually controllable such that they can emit at various sum values of intensity.

FIG. 6 is an isometric view of one embodiment of a polyhedral core, one embodiment of a thermally conductive or heat pipe support coupled to the polyhedral core and one embodiment of a heat exchanger coupled to the support.

Those skilled in the art to which this application relates will appreciate that other and further additions, deletions, substitutions and modifications may be made to the described embodiments.

What is claimed is:

1. A quasi-point source light emitter, comprising:
a polyhedral core having a plurality of flat polygonal faces structurally arranged for a quasi-omnidirectional point source; and
planar light emitting devices or arrays thereof located on the plurality of flat polygonal faces and having planar light emitters that are controlled individually or controlled collectively for the quasi-omnidirectional point source.

2. A method of operating a quasi-point source light emitter, comprising:
arranging a plurality of flat polygonal faces to form a quasi-omnidirectional point source; and
energizing planar light emitting devices or arrays thereof on the plurality of flat polygonal faces, wherein planar light emitters are controlled individually or controlled collectively to provide the quasi-omnidirectional point source.
